(19) United States
(12) Patent Application Publication
(10) Pub. No.: US 2017/0270553 A1
(43) Pub. Date: Sep. 21, 2017

(54) MARKETING AND REFERRAL SYSTEM AND METHOD FOR INTEGRATING AND NETWORKING BUSINESS AND SERVICE PROVIDERS

(71) Applicants: Joseph Trovato, JR., Allentown, NJ (US); Joseph Trovato, III, Brooklyn, NY (US)

(72) Inventors: Joseph Trovato, JR., Allentown, NJ (US); Joseph Trovato, III, Brooklyn, NY (US)

(21) Appl. No.: 15/465,584

(22) Filed: Mar. 21, 2017

Related U.S. Application Data
(60) Provisional application No. 62/311,389, filed on Mar. 21, 2016.

(51) Int. Cl. G06Q 30/02

(52) U.S. Cl. CPC G06Q 30/0214; G06Q 30/0235; G06Q 30/0226

(57) ABSTRACT

The present invention comprises a comprehensive system and method for networking a plurality of businesses and service providers and their customers for the purpose of promoting the businesses and services of each, while maintaining the privacy of all of their customers. In preferred embodiments, a central database maintains one or a plurality of provider networks, each network including a plurality of providers, and each provider having a plurality of customers. The database maintains a profile for each customer, and accounting information relating to promotional programs that provide an incentive for customers and providers to refer new customers. The database also includes a provider interface inviting new providers to sign up to join a network, and for existing providers in a network to allow or block new providers from joining their network. The database also includes a customer user interface enabling customers to join a network, to add available providers to their network, to maintain their profile, to register new customers into incentive programs, and to redeem or transfer bonus points from the incentive programs.

### RELATED APPLICATION

This application is a non-provisional filing of and claims priority to U.S. Provisional Application No. 62/311,389, entitled “MARKETING AND REFERRAL SYSTEM AND METHOD FOR INTEGRATING AND NETWORKING BUSINESS AND SERVICE PROVIDERS, and filed on Mar. 21, 2016; which is incorporated herein by reference.

### TECHNICAL FIELD OF THE INVENTION

The present invention relates generally to the field of computer-implemented methods for promoting customer loyalty and patronage at a plurality of businesses and service providers.

### BACKGROUND OF THE INVENTION

It is not uncommon for there to exist a plurality of businesses or service providers that offer products and services to customers in a geographic area while the products and services between two such providers minimally compete with each other. For example, a plurality of local doctors and dentists may each have private practices with different medical specialties. Or, a plurality of specialty boutiques may offer unique merchandise that compliments the other boutiques. In such cases, a customer patronizing one of these providers might possibly discover that they also have a need for the products and services that are offered by another complimentary provider. If left totally to chance, the customer will select a provider for the additional services randomly from among all available local providers. However, from the perspective of a particular local provider who offers that product or service, it would be beneficial to be able to influence the customer's choice so that they will preferentially choose them over all other available local providers.

One way for a provider to influence the choice of a customer is to send promotional material to the customer. For example, a first provider, who offers a complementary business or service to a second provider may ask the second provider to supply a list of customers and their addresses, so that the first provider can send promotional material. However, for some businesses and services, particularly in the medical professions, there are privacy laws, in addition to general privacy concerns, that prohibit or counsel against the release of confidential and private information from one entity to another, including prohibiting the dissemination of any medical or personal health information, social security numbers, and even the mere identities of customers.

It can also happen that a second customer may solicit or otherwise receive from a first customer a recommendation for a provider of a particular business or service. In such case, the first customer may recommend a particular provider because of a positive experience he or she has had at that provider and the desire to share that experience with the second customer. This process is known as “Word of Mouth” recommendation.

It can also happen that the second customer has had a positive experience at several local providers who provide similar products or services. In such case, it would be desirable for a successful provider to be able to ensure that they will be recommended over all of the other providers when a customer provides a word of mouth recommendation.

### BRIEF SUMMARY OF THE INVENTION

The present invention comprises a comprehensive system and method for networking a plurality of businesses and service providers (hereinafter “providers”) and their customers for the purpose of promoting the businesses and services of each of the providers in the network, while maintaining the privacy of all of their customers. In preferred embodiments, a central database maintains one or a plurality of provider networks, each network including a plurality of providers, whose products and services may be overlapping and/or non-overlapping. The database also maintains a profile for each customer, and accounting information relating to promotional programs that provide an incentive for customers and providers to refer new customers. The database also includes a provider interface inviting new providers to sign up to join a network, and for existing providers in a network to allow or block new providers from joining their network. The database also includes a customer user interface enabling customers to join a network, to add available providers to their network, to maintain their profile, to register new customers into incentive programs, and to redeem or transfer bonus points from the incentive programs. These and other benefits of the present invention may be further appreciated in the drawings appended herewith and the detailed description of preferred embodiments which follows. However, the full scope of the invention should not be limited by this brief summary or by the detailed description of preferred embodiments, but should only be limited by the claims appended herewith.

### BRIEF DESCRIPTION OF THE DRAWINGS

FIG. 1 shows a typical network according to a preferred embodiment of the invention, such as might be seen by a customer logging into the central database.

FIG. 2 shows a typical screen relating to transaction and network management functions as might be seen by a provider logging into the central database.

FIG. 3 shows another typical screen for a provider, relating to business referral data.

FIG. 4 shows another typical screen for a provider, relating to the business profile data.

FIG. 5 shows another typical screen for a customer, relating to a customer referral data.

FIG. 6 shows another typical screen for a customer, relating to the account history.

### DETAILED DESCRIPTION

The present invention comprises a comprehensive system and method for networking a plurality of providers and their customers for the purpose of promoting the businesses and services of each of the providers in the network. The present invention recognizes that the prevalence of customers in a referral system who can make “Word of mouth”-type recommendations based on personal experience, can greatly enhance the marketing success of the system, because of the strong relationship between the customers. In marketing language, such recommending customers with a personal relationship to another customer can be considered “strong influencers” on purchasing decisions of the other customer.

The present invention also recognizes that to increase the prevalence of such customers, it is desirable for at least three-quarters of the business of each of a high enough percentage of the providers in the system to consist of rendering personal services and products in close proximity to a customer. The foregoing type of provider, wherein a sufficient percentage of their business consists of rendering services or selling products in close proximity to a customer, is referred to hereinafter as a “preferred provider”. The personal services and products could be rendered at a facility of the provider, or at another location where the services are rendered by an authorized representative of the provider. This is easily understood when the services are dental, medical or gym services for instance. Such services can also, for instance, be the providing of food that is cooked or otherwise ready to eat, either at a restaurant, or delivered to the customer's location. In essence, “close proximity” means that a customer is willing to travel to patronize the business. Close proximity may also include those businesses that have an internet presence, and which provide goods that are delivered directly to customers.

Including a high enough (an “effective”) percentage of “preferred providers” as defined above, increases the likelihood that customers of those providers will be willing to recommend their services to other potential customers (presumably also in close proximity), as those customers can conveniently travel to the provider to receive services or goods. The customers eventually become, in essence, marketing agents for the provider. Furthermore, including an effective percentage of preferred providers within the network can have the additional advantage of attracting other preferred providers to join the network, in view of the likelihood that they could target promotional advertisements to the strong influencers (i.e., “word of mouth” customers) of other providers already in the network. It is believed that an effective percentage of such preferred providers is 40 percent, with the desirability increasing with increasing percentage. Thus, an effective percentage may be 40 percent, more preferably 60 percent, even more preferably 80 percent, and especially more preferably 90 percent or more.

The present invention comprises a comprehensive system for accomplishing the above goals. In preferred embodiments, the system comprises a central database which maintains information relating to one or a plurality of provider networks, each such network including a plurality of providers. The providers may have overlapping, partially overlapping, or preferably non-overlapping businesses or services. Also included in the database is information relating to customers who have joined the network, either because they are customers of providers in the network, or because they have joined independently, Associated with the central database are typical database maintenance and security functions, such as automatic backup of the stored data, and protection against unauthorized access.

When new potential providers indicate an interest in joining the network system, they may select which network to join, and existing providers in a particular network may accept the new providers into the network. Once in the network, providers may advertise to customers in the network various promotions that may be available to them without compromising any personal data. Advertisements may be in a variety of forms, such as emails and text messages, banners that appear on smart phones or web interfaces, and snailmail. Built into the system of the instant invention is a referral process that allows customers to earn points for referring new customers to particular providers in the network. Customers may also receive points in a hierarchical fashion if a second customer that they previously referred, also refers a third customer to the business, and so on; with the iteration of bonuses for the first customer accumulating up to a predetermined depth that may be selected in advance by the provider. This hierarchical referral process will be described in further detail, below. Customers may also log into the networking system to view their accounts and accumulated points, and perform other functions.

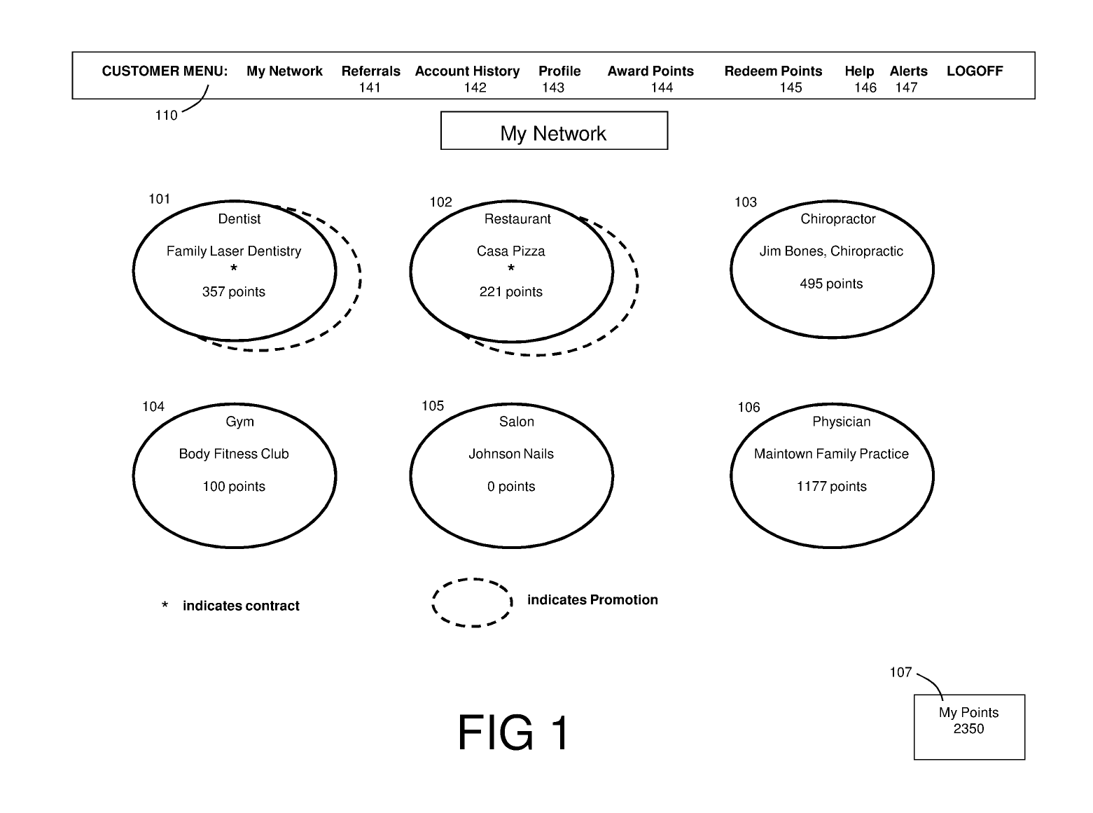

An example of such a network of local providers may be seen in FIG. 1, representative of a typical screen visible to a customer after logging into their network database account. In this example, six local providers are displayed, a dentist 101, a restaurant 102, a chiropractor 103, a gym 104, a salon 105, and a physician 106. Two of these providers (dentist 101 and restaurant 102) are shown as currently offering additional promotions. The manner in which customers may receive bonus points from providers offering promotions will be explained in further detail, below. FIG. 1 also shows the current cumulative points that this customer has earned to date from the various promotions at each of the providers, for example, 357 points from Family Laser Dentistry 101, etc., and the total number of points earned from all of the providers, 107.

Across the top of FIG. 1 is displayed a typical menu bar indicating other functions available to the customer while logged into the network database. Each of these functions will be discussed in further detail, below.

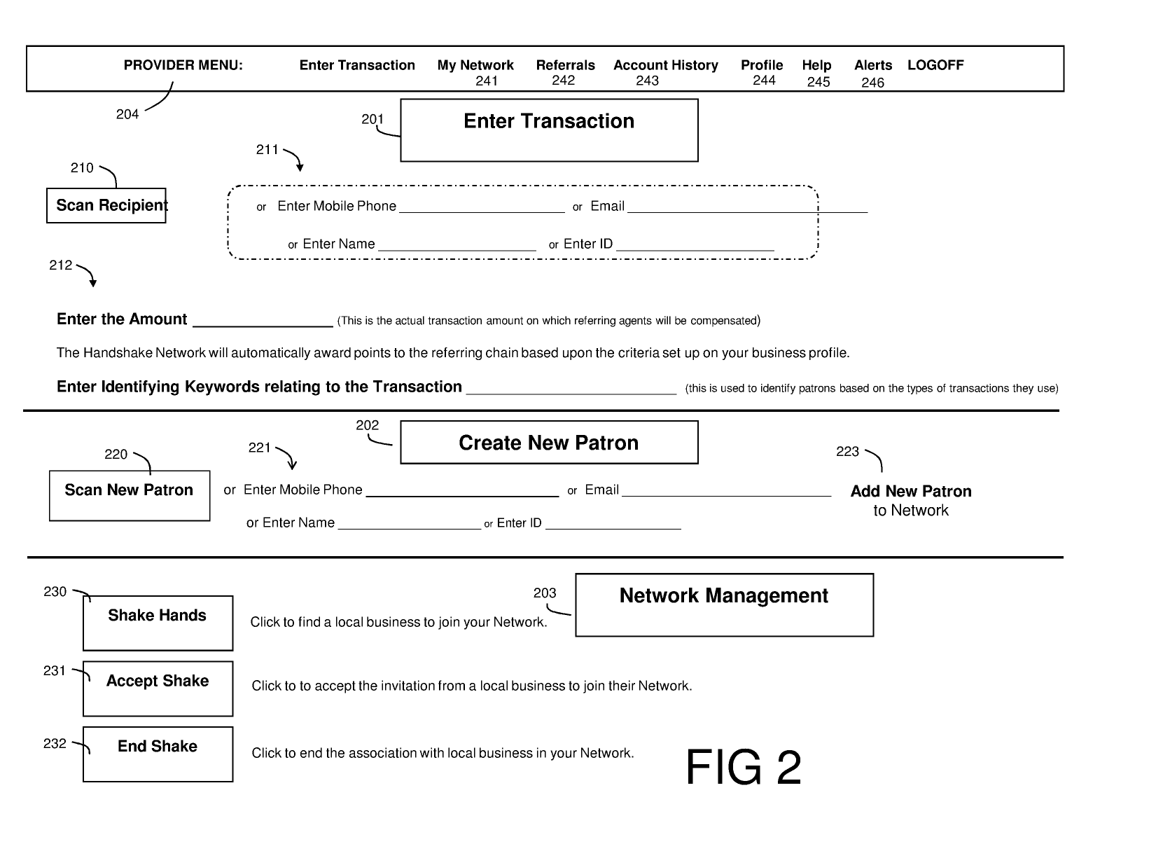

Similarly to the Customer online access to the network database, Providers also may access the network database to perform a variety of actions. For example, FIG. 2 shows a representative screen displayed on a monitor by the network database so that a provider can enter a transaction for a particular customer at their facility. It should be understood that the screens shown in this specification are only examples of screens that might be employed to practice this invention. Those skilled in the art of online screen design and/or phone application design may find other ways to present the information, or to enable the user with functions that allow the operations necessary to perform this invention. Accordingly, these screens should not be taken as limiting the instant invention.

Near the top of the representative screen shown in FIG. 2, in the section “Enter Transaction” 201, the provider may scan 210 a data card, logo, invisible data, RFID module, smart phone or other identity device held by the customer, or may manually enter 211 identifying information corresponding to the customer, such as mobile phone number, email, name, ID, etc. The screen further requests 212 the amount of the transaction, so that the network database can properly award the necessary bonus points to the customer for any ongoing promotions, and to any other customers who are linked to this customer because of the hierarchical referral program to be discussed in further detail later. Optionally, the transaction information may include identifying keywords relating to the type of transaction. For example, in the case of a fitness club, the information may indicate whether the transaction is a routine membership fee, or a purchase of a special food supplement. This information may then be used by the network database system for the purpose of sending targeted alert messages anonymously from one provider to another provider's customers, as described further below. Of course, rather than manually entering all of the transaction information, the provider may allow their POS (point-of-sales) terminal system to be linked to the network database system, so that all of the necessary transaction information is automatically uploaded to the network database system. This can be carried out in real-time, or batched for transmission on a periodic basis, such as at the end of the day.

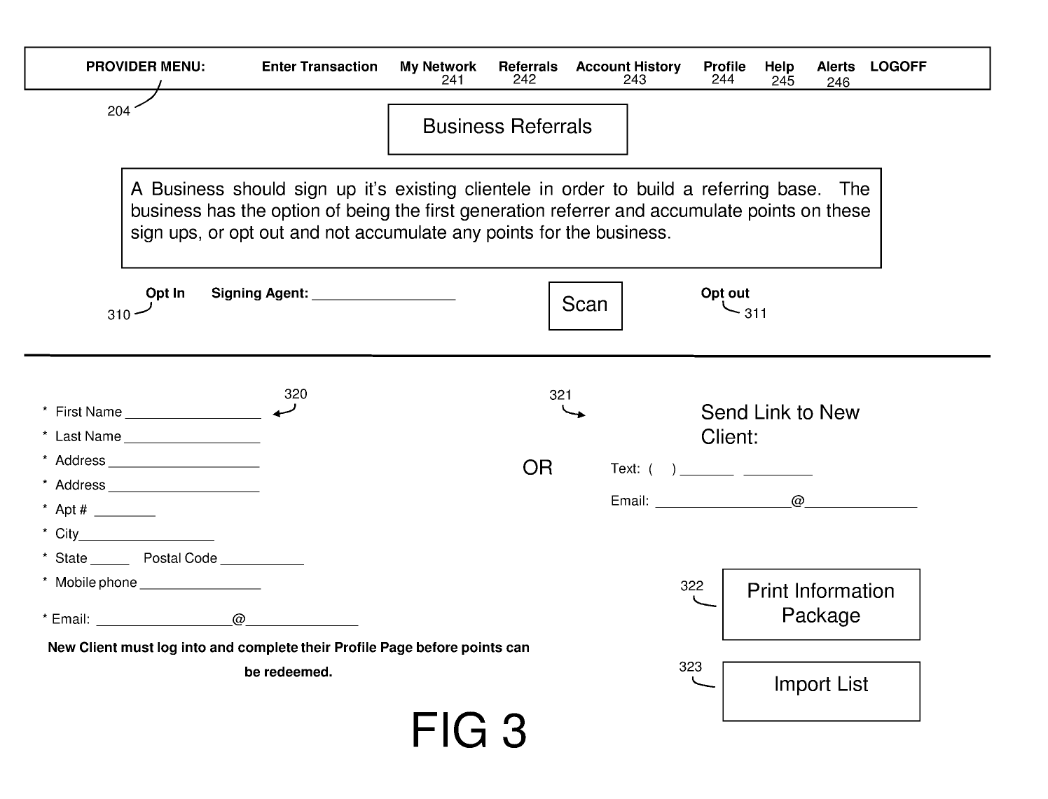

In the middle of the screen 202 as shown in FIG. 2, the provider may enter 220 a new customer (patron) to be associated with that provider. For the particular embodiment of the network database interface shown in FIG. 2, the procedure to add a new customer for that provider is similar to the first steps carried out to record a transaction, namely, scanning 220 a data card or RFID module held by the customer or entering manually 221 the customer's identifying information. This procedure assumes that the new customer already has an entry in the network database, either because they are already registered with another provider in the network, or because they previously signed up directly with the database. Or, in case the customer is totally new to the network, the screen includes function 223 that opens a new screen (discussed in connection with FIG. 3) that allows the provider to add a customer to the network, by filling in some preliminary data for the customer (such as their name, phone number, etc.). The customer may then log into the network database at a later time to fill in additional information that may be considered confidential and to be withheld from that provider (for example, a Social Security Number).

At the bottom 203 of the screen in this particular example, are displayed three network maintenance functions that may be performed by the provider. The “Shake Hands” function 230 allows the provider to find local providers to recommend joining the network. This function opens a new screen (not shown) that presents a list of local providers, or that allows searching the internet to find such providers. Once the provider or providers are located, a second function on that screen allows the existing provider to initiate a “handshake” with those potential new providers. This handshake consists of sending a message, such as an email message, to the other providers requesting them to join, and providing a link so that they can review the benefits of becoming a member of this network.

The second function 231 in the network management section allows the provider to accept a “handshake” request from another provider.

The final function 232 allows a provider to exit any association with the network. In case there are pending bonus award points that the provider owes to any of the customers, the provider will be blocked from ending the association with the network until those bonus points are properly paid.

The top of the screen in FIG. 2 shows 204 the available menu items when a provider logs into the network database. The “My Network” function 241 opens a screen (not shown) which displays a list of providers already in the instant provider's network, in a format of display that may be similar to the My Network display that is shown to a customer when checking their network providers. There is a link to the network management functions found at the bottom of FIG. 2, or these functions can be included directly on this screen.

The Referrals menu function 242 opens a screen such as shown in FIG. 3, which allows the provider to select whether to Opt In 310 or Opt Out 311 of sending links to their existing customers to join the present network. In the bottom section of the screen, the provider may enter 320 information about each customer that they want to recommend to join the network. Or, they can send 321 a link to the customer. The provider may also print 322 an information package. In case the provider has a long list of customers, the provider can import 323 a list containing the relevant information or requests for sending a link. This section of FIG. 3 also shows the options available to a customer who is referred to the provider as discussed in connection with FIG. 2.

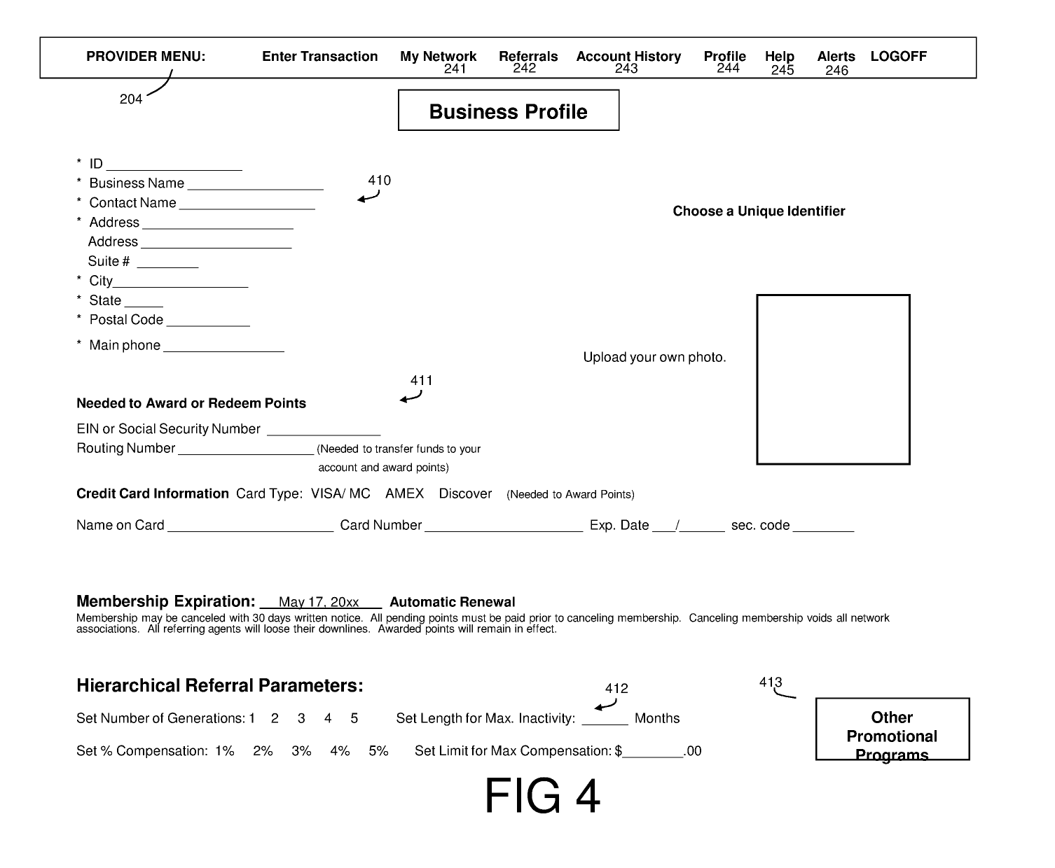

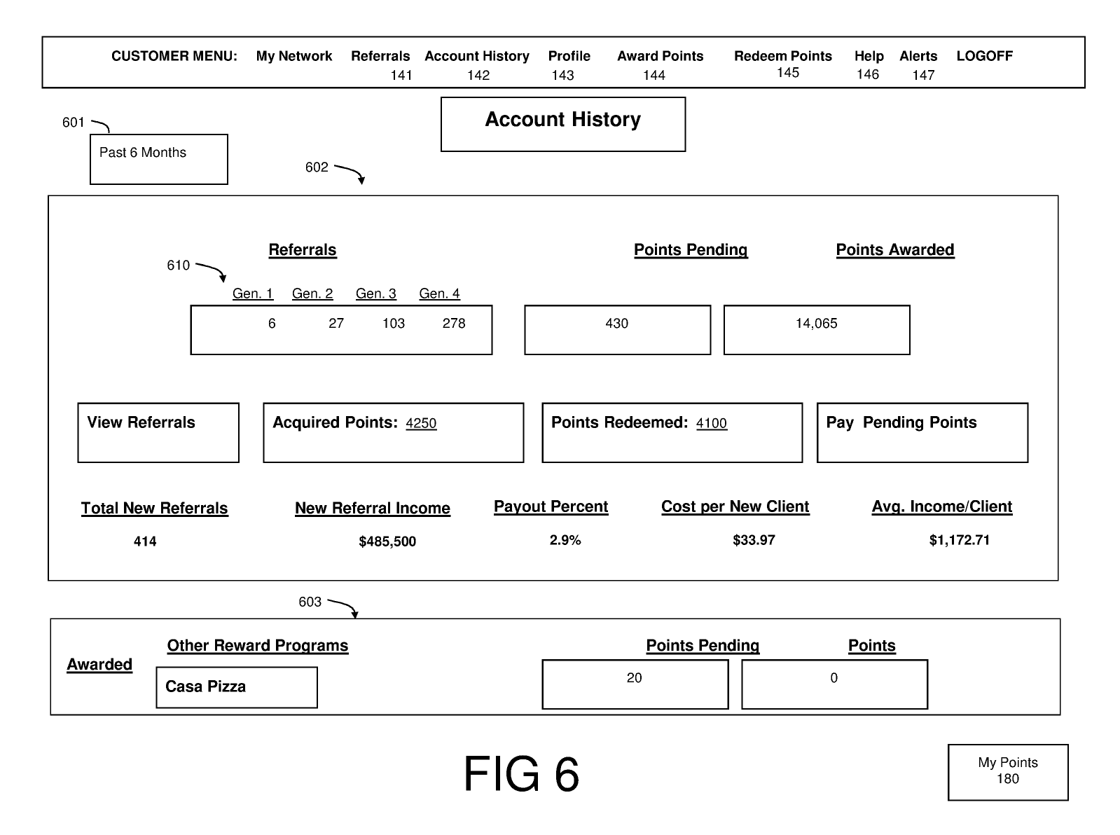

The Account History menu function 243 opens a screen (not shown) which allows the provider to display the most recent bonus rewards that have been earned by customers (discussed in more detail in connection with FIGS. 4 and 6), and to show the current balance of bonus rewards that are owed (earned, but not yet paid to customers).

The Profile menu function 244 opens a screen such as shown in FIG. 4, displaying and allowing the provider to edit the various parameters associated with the provider's membership in the network. In 410, the provider may enter/view the basic information such as the ID, Name, Address, etc. In 411, the provider may enter/view financial information, such as bank account information, credit card information, etc. Because the provider will potentially receive bonus awards from other providers for referrals, or will potentially be paying bonus awards to other providers or customers for referrals or other bonus promotions, it is necessary that the network database has the information to carry out these transactions. The primitive format for the financial information shown in section 411 could of course be embellished significantly to allow selection/allocation to/from multiple bank accounts or credit cards or other financial vehicles such as PayPal™, etc. in a manner that is known to those skilled in the art.

Of particular interest to the instant invention is section 412 relating to the Hierarchical Referral Parameters. In this section the provider can select the depth of generations of hierarchy, and the percentage of transaction amount to be awarded for each generation. What is displayed in this representative embodiment is a simple compensation scheme based on an equal compensation percentage for each generation in the hierarchy. Since the goal is to provide an incentive for customers and providers to refer other customers and to increase patronage of the providers in the network, the network system also allows the provider to set other parameters to try to promote frequent usage. For example, the provider may set an expiration time (not shown in 412) for referrals to count toward the program, or the maximum inactivity time between referrals and/or transactions. When the inactivity time is reached, the system may cause some or all of the Hierarchy tree to be disabled, either temporarily or permanently, and a message may be sent to the customer or other affected customers in the Hierarchy tree. A max compensation value may also be set, which can control the total amount a customer may receive, or alternatively control that amount over a period of time (e.g., quarterly). Other more complicated referral compensation programs may also be contemplated, which also come under the scope of the instant invention. For example, but not by way of limitation, the compensation percentages may diminish evenly or according to a particular function as the depth of generations increases. For these more complicated compensation functions, a correspondingly advanced user interface (not shown) allows the provider to select exactly the type and form of compensation to be offered for each generation, and corresponding expiration or inactivity times under the advanced hierarchical referral program, as will be readily appreciated by those skilled in the art.

Also shown is function 413 which opens a screen (not shown) enabling the provider to initiate/control other promotional programs that will be covered by the network database system. For example, a provider may decide that they will offer a certain number of points for each transaction amount during a specified period of time, covering a particular class of merchandise or services. In addition, the provider may activate an automatic link that will authorize the network database system to automatically send out messages relating to that promotional program to designated customers, as described more completely below in connection with the Alerts menu function 246.

The Help menu function 245 provides a screen (not shown) offering advice, FAQs, troubleshooting, etc. to the provider to aid in using the network database system.

The Alerts menu function 246 provides a screen (not shown) that allows the provider to send messages to and receive messages from providers and customers within the network. Messages may be sent as follows:
1) From the provider to other providers in the network.
2) From the provider to individual customers or groups of customers that are already registered with that provider.
3) From the provider to anonymous customers registered with another provider or a plurality of other providers. In other words, the provider that sends the message does not know the identity of the receiving customer(s) other than that they are customers at a different provider (unless the customer has already registered with the sending provider).
   The Alerts screen also allows the provider to view messages received from other providers and customers.

The primary purpose for sending Alerts is to notify customers of potential special promotions that are currently in progress or soon to be in progress, as indicated above. For example, a provider may want to notify their own customers that a sale is presently in progress. Prior to joining the network database system, this could have been accomplished directly from the provider using their lists of customer contacts. But more importantly, the instant invention allows the provider to increase their potential customer base by notifying the customers of another provider about a promotion. Since in many cases it is important that each provider maintain in confidence the identify of their customers from every other provider, it is believed that it was difficult or not possible, prior to the instant invention, for a first provider to send messages directly to the customers of a second provider without knowing contact information of the customers. Accordingly, the instant invention includes the ability to rapidly target customers of other providers and send them promotional material without the sender knowing personal identities of the customers. Additionally, if detailed transaction information has been provided to the network database system, as discussed in connection with FIG. 2, the provider may be able to target specific subgroups of customers belonging to a different provider. The targeted set of customers may range from as few as a single customer to all customers of the different provider. Advertisements may be in a variety of forms, such as emails and text messages, banners that appear on smart phones or web interfaces, and snailmail.

Having now described the menu functions associated with the provider's interface to the network database system, the menu functions associated with the customer's access will now be described. Referring again to FIG. 1, these menu functions are listed at the top of the screen.

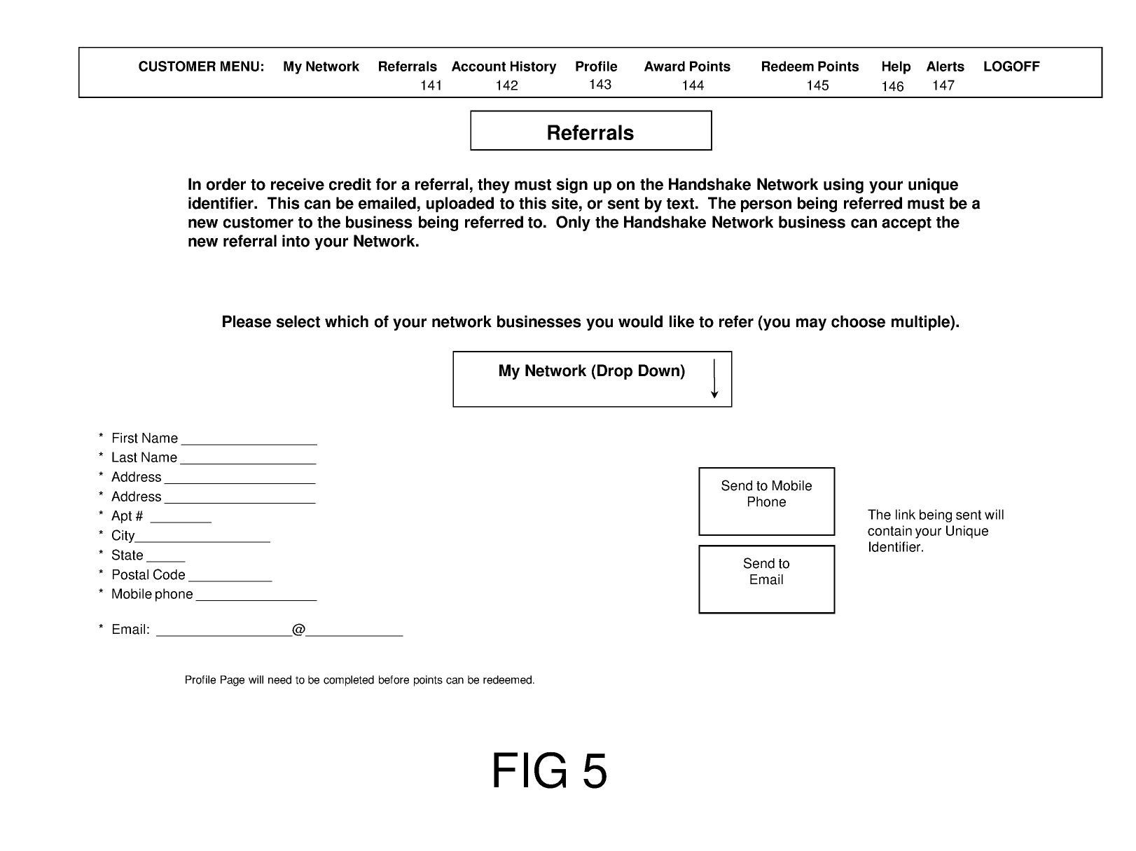

The Referrals menu function 141 opens a screen such as shown in FIG. 5, which allows a customer to initiate a link to a potential new customer for a provider. In a similar fashion to the provider's referral screen of FIG. 3, the originating customer may select one or more providers and provide preliminary contact information for the potential customer. If the designated new customer decides to join the network and/or to patronize the targeted providers (or optionally, to target other providers that the originating customer is not aware of), then the originating customer will receive bonus referral points each time the new customer has a transaction. As described above, when the hierarchical referral program is active, customers referred by the new customer will also earn points for the originating customer.

The Account History menu function 142 opens a screen such as shown in FIG. 6, which allows the customer to review the points currently earned according to the various rewards programs that are active. In this representative embodiment, the customer first selects 601 the time period to be covered on the screen. The network database system then provides a summary of all rewards earned so far during that time period. Section 602 presents the accounting for the hierarchical referral program. In section 610, the number of referrals corresponding to each generation level of referrals is indicated. Additional information is provided relating to the points earned by these referrals, and so forth. As discussed above, the hierarchical referral program shown in this representative embodiment has been simplified in order to more readily present the essential aspects of this invention. However, more complicated hierarchical referral programs involving various compensation functions and time limitations also fall within the scope of the invention, and the necessary interfaces enabling the customer to view the current status of their participation in the programs can be constructed in a straight-forward fashion by those skilled in the art.

The Account History screen also allows 603 the customer to view bonus points earned in other promotions that are covered by the network database system.

The Profile menu function 143 activates the customer's profile page (not shown), which, for this representative embodiment, is similar to the provider's Profile shown in FIG. 4 with the exception that it does not include section 412 relating to setting up the compensation amounts for the Hierarchical Referral Program. As with the provider's Profile, the network database also maintains financial information for each customer in the network, such as a bank account or credit card account, etc., in order to allow the system to provide automatic reimbursement for the points earned in the referral and other promotions.

Of particular interest to the present invention, customers can select different levels of privacy regarding information that could be used by a provider to learn their identity, such as their name, Social Security Number, postal or email addresses, home or work telephone numbers, cell phone number or social media identifiers (hereinafter, “identity-related information”). In particular, in a preferred embodiment, customers can select from the following three levels of privacy regarding identity-related information:

(1) Keep identity-related information private from all providers which send marketing material to customers of another provider.
(2) Allow all providers access to at least some identity-related information (for example, name and postal address, but not Social Security Number).
(3) Keep identity-related information private from selected providers which send marketing material to customers of another provider, while allowing other providers access to at least some identity-related information (for example, name and postal address, but not Social Security Number).

The Award Points menu function 144 opens a screen (not shown) that allows a customer to transfer earned points to another customer.

The Redeem Points menu function 145 (not shown) allows a customer to convert earned points under the various bonus programs into actual money, by authorizing the money to be sent to a bank, credit card, smart phone, paypal, etc.

The Help and Alerts menu functions 146 and 147 open screens (not shown) that operate in a similar fashion for the customer as for the providers. However, customers generally are limited to receiving alerts (such as sales promotions, etc.) from providers rather than contacting other customers. If desired, the network database system may allow customers to send messages to providers.

The appended claims set forth some of the combinations of elements described herein that are deemed to be within the scope of the present invention. However, all other reasonable combinations of elements are deemed to be within the scope of the invention, wherein “reasonable” connotes the ability of various elements to function together for any of the goals set forth herein.

Having described a typical function and operation of the network database system by means of representative embodiments, it should be understood that the disclosed system offers a significant improvement for business and service providers and their customers in matching their products and services in an efficient and, if desired, anonymous fashion. While the above description and appended drawings exhibit features of the invention using only preferred embodiments of the present invention, the numerous variations and modifications that will become apparent to those skilled in the art, having benefit of this description, are rightly also considered part of this invention, and so the invention should be limited only by the claims appended herewith.

What is claimed is:

1: A multi-provider customer referral system, comprising:
A central database server, containing a database that holds information about providers that belong to the system and customers that patronize at least one of the providers that belong to the system, and further includes relational data indicating which of the customers have referred which other customers to at least one of the providers;
Wherein said information about providers includes at least one parameter determining the referral depth of customers in said referral system and at least one parameter determining a length of time during which said referral bonuses are active;
Means to update the database whenever a customer has a transaction with a provider in the database, wherein said update includes computing a referral bonus for each customer linked directly or indirectly by said relational data to said customer that has a transaction with a provider in the database;
A remotely accessed interface that allows providers to join or leave the system and to update their provider profile settings, including changing the referral depth stored in said database, and allows customers to check and redeem their accumulated referral bonuses.

2: The system of claim 1 wherein said information about providers includes a table indicating the referral bonus to be calculated for each transaction based on the referral depth and the length of time during which said referral bonuses are active.

3: The system of claim 1, wherein the central database system includes an effective percentage of preferred providers who perform business with a sufficient percentage of customers who live in close proximity.

4: The system of claim 3, wherein said effective percentage of preferred providers is at least 40 percent.

5: The system of claim 3, wherein said effective percentage of preferred providers is at least 60 percent.

6: The system of claim 3, wherein said effective percentage of preferred providers is at least 80 percent.

7: The system of claim 3, wherein said effective percentage of preferred providers is at least 90 percent.

8: The system of claim 1, wherein at least three-quarters of the business of each of at least 40 percent of said providers that is marketed on said system consists of rendering personal services in close proximity to a customer.

9: The system of claim 1, wherein at least three-quarters of the business of each of at least 80 percent of said providers that is marketed on said system consists of rendering personal services in close proximity to a customer.

10: A method for computing referral bonuses in a multi-provider customer referral system, said method comprising:
Storing information about providers that belong to the system and customers that patronize at least one of the providers that belong to the system, and storing relational data indicating which of the customers have referred which other customers to at least one of the providers;
Wherein said information about providers includes at least one parameter determining the referral depth of customers in said referral system and at least one parameter determining a length of time during which said referral bonuses are active;
Updating the database whenever a customer has a transaction with a provider in the database, wherein said updating includes computing a referral bonus for each customer linked directly or indirectly by said relational data to said customer that has a transaction with a provider in the database;
Providing a web interface that allows providers to join or leave the system and to update their provider profile settings, including changing the referral depth stored in said database, and allows customers to check and redeem their accumulated referral bonuses.

11: The method of claim 10 wherein said information about providers includes a table indicating the referral bonus to be calculated for each transaction based on the referral depth and the effective length of time during which said referral bonuses are active.

12: The method of claim 10, wherein the central database system includes an effective percentage of preferred providers who perform business with a sufficient percentage of customers who live in close proximity.

13: The method of claim 12, wherein said percentage of preferred providers is at least 40 percent.

14: The method of claim 12, wherein said effective percentage of preferred providers is at least 60 percent.

15: The method of claim 12, wherein said effective percentage of preferred providers is at least 80 percent.

16: The method of claim 12, wherein said effective percentage of preferred providers is at least 90 percent.

17: The method of claim 10, wherein at least three-quarters of the business of each of at least 40 percent of said providers that is marketed on said system consists of rendering personal services in close proximity to a customer.

18: The method of claim 10, wherein at least three-quarters of the business of each of at least 80 percent of said providers that is marketed on said system consists of rendering personal services in close proximity to a customer.

19: A method for allowing a first provider to send marketing material to customers of a second provider while maintaining a customer-selectable level of privacy for each of those customers, comprising:
Establishing a secure central database capable of storing information about at least two providers;
Establishing interface means enabling said first and second providers to enter information into said central database, wherein said information includes contact information relating to at least some customers of each of their respective businesses;
Allowing said first provider to establish a target set of customers of said second provider while maintaining the customer-selectable level of privacy of said customers in said target set;
Receiving marketing material from said first provider; and
Relaying said marketing material to at least one customer of said target set of said second provider while maintaining the customer-selectable level of privacy for each customer.

20: The method of claim 19, wherein the customer-selectable level of privacy prohibits disclosure of any information that could be used to identify a customer.
